(19) United States
(12) Patent Application Publication
(10) Pub. No.: US 2024/0349764 A1
(43) Pub. Date: Oct. 24, 2024

(54) PULSE-BASED PASTA AND PROCESS FOR MANUFACTURING THE SAME

(71) Applicant: AGT Food and Ingredients Inc., Regina (CA)

(72) Inventors: Murad Al-Katib, Regina (CA); Gaetan Bourassa, Regina (CA); Huseyin Arslan, Mersin (TR); Eric Bartsch, Bismarck, ND (US); Les Knudson, Crosby, ND (US); Davide Vitale, Rivalta Bormida (IT); Mehmet Tulbek, Saskatoon (CA)

(21) Appl. No.: 18/761,166

(22) Filed: Jul. 1, 2024

Related U.S. Application Data
(62) Division of application No. 16/009,657, filed on Jun. 15, 2018, now abandoned.
(60) Provisional application No. 62/520,369, filed on Jun. 15, 2017.

(51) Int. Cl. A23L 11/00; A23L 5/00; A23P 30/20

(52) U.S. Cl. CPC A23L 11/05; A23L 5/55; A23P 30/20; A23V 2002/00

(57) ABSTRACT

A pulse-based pasta and a method of manufacturing the pulse based-pasta using a heat and moisture treatment process. The method may comprise hydrating and heating a limited protein pulse fraction to produce a hydrated pulse dough; agglomerating the dough; drying the dough to a moisture content of less than about 10% moisture; rehydrating the dough and cooking the dough to produce a cooked pulse dough; extruding the cooked pulse dough to produce an extruded pasta; and drying the extruded pasta to produce a dried pasta with a moisture content between about 5% to 12.5% by weight. The pulse pasta may comprise a protein of about 11.8% by weight or in a range of 4% to 16%; carbohydrates of about 73% by weight or in a range of 10 73% to 90%; and a moisture of about 10% by weight or in a range of 5% to 12.5%.

### CLAIM TO PRIORITY

This application is a division of application Ser. No. 16/009,657, filed Jun. 15, 2018, which claims the benefit of U.S. Provisional Application No. 62/520,369, filed Jun. 15, 2017, each of the above applications being incorporated herein by reference in its entirety.

### TECHNICAL FIELD

This invention is in the field of pulse based-pasta production by using processed pulse flours, and more specifically processed using a heat and moisture treatment process.

### BACKGROUND

Conventional manufacturing of dried pasta involves hydrating gluten containing common wheat and durum wheat flour with water to form a pasta dough. The pasta dough is then cold extruded (e.g., in a temperature range of 45-60° C.) and dried to create shelf-stable pasta. A strong protein and starch network is formed due to the gluten presence in the flour. The protein network helps hold the pasta together after drying and holds the flour starch together during cooking. Without the strong protein and starch network, the pasta falls apart into constituent components either before cooking or while cooking.

A pasta product formed from a low-protein flour is described in U.S. Pub. No. 2017/0035082 to Tutuncu et al. The pasta is formed from the low-protein flour by blending it with water to form pasta dough. The low-protein flour may range from 3% dry weight protein to 12% dry weight protein. The pasta dough is then hot extruded to produce extruded pasta before being dried. In contrast to cold extrusion where the goal is to minimize starch gelatinization while shaping the pasta dough, hot extrusion causes starch within the low-protein flour to gelatinize. The gelatinized starch compensates for the lack of protein network structure caused by using a low-protein flour.

A process for the production legume meal is described in W.O. Pub. No. 2016/120234 to Ambiente E Nutrizione S.R.L. The process comprises the steps of: a) providing a wet heat treatment reactor comprising a cylindrical tubular body with horizontal axis, having an opening for the introduction of legume meal and water or an aqueous solution and having at least one discharge opening, a) heating jacket and a rotor arranged inside the cylindrical tubular body; b) feeding a continuous flow of meal into the reactor, in which the rotor is rotated at a speed greater than or equal to 150 rpm; c) feeding into the reactor, together with the flow of meal, a continuous flow of water or aqueous solution, which is dispersed into minute droplets; d) centrifuging the aforementioned flows against the inner wall of the reactor, thus forming a highly turbulent, dynamic, thin tubular fluid layer, while advancing in substantial contact with the inner wall of the reactor towards the discharge opening; e) discharging from the discharge opening a continuous flow of a wet meal (moisture content 20-40%); f) providing a thermal dehydration and treatment reactor, comprising a cylindrical tubular body with horizontal axis, having at least one inlet opening and at least one discharge opening, a heating jacket and a rotor arranged inside the cylindrical tubular body and comprising a shaft provided with elements projecting radially therefrom; g) feeding the wet meal into the thermal dehydration and treatment reactor, the inner wall of the reactor being kept at a temperature of at least 100° C. and the rotor being rotated at a speed of at least 150 rpm; h) centrifuging and causing the wet meal to advance inside the reactor by the action of the rotor; i) discharging from the discharge opening of the reactor a continuous flow of legume meal having a moisture content of between 2% and 15%.

### SUMMARY

In some of the aspects described herein, there is provided a method of manufacturing a pulse-based pasta from pulses. A mixer may hydrate a limited protein pulse fraction to between about 18% to about 50% by weight with water in a temperature range of about 25° C. to 85° C. at atmospheric pressure to produce a hydrated pulse dough with a temperature range of about 65° C. to about 85° C. The hydrated pulse dough may be agglomerated to produce agglomerated pulse dough. The agglomerated pulse dough may be heated at about 95° C. to about 150° C. to cook and dry the agglomerated pulse dough to a moisture content of less than about 10% moisture. Rehydrating the agglomerated pulse dough to a moisture range from about 25% to about 43% by weight and cooking the agglomerated pulse dough in a barrel of a screw extruder to produce a cooked pulse dough. The cooked pulse dough may be extruded to produce an extruded pasta. The extruded pasta may be dried to produce a dried pasta with a moisture content between about 7% to 12.5% by weight. The dried pasta may be packaged.

In some of the aspects, the method may further comprise separating, using classification, a raw pulse flour into the limited protein pulse fraction and a medium-protein pulse fraction. In another aspect, the method may further comprise blending a medium-protein pulse fraction and a starch to produce the limited protein pulse fraction.

The method may comprise dehulling at least one hulled pulse prior to milling to produce the at least one dehulled pulse and at least one outer hull. The method may comprise milling at least one dehulled pulse to produce the raw pulse flour. The method may comprise cleaning the at least one hulled pulse. The raw pulse flour may comprise particle sizes of below about 80 microns. A protein range of the limited protein pulse fraction may be less than about 16% dry weight. In particular, the protein range of the limited protein pulse fraction may be within a range of about 7% to about 16% dry weight.

In some aspects, the limited protein pulse fraction may be hydrated to between about 25% to 43% by weight. In particular, the limited protein pulse fraction may be hydrated to between about 27% to about 33% by weight.

In some aspects, the method may comprise milling the heated agglomerated pulse dough through a mesh having a sieve size of about 0.150 mm.

In some aspects, a temperature of the agglomerated pulse dough within the barrel of the screw extruder may range from about 105° C. to about 125° C. at atmospheric pressure. A cooking temperature within the barrel of the screw extruder may range from about 100° C. to about 125° C. at high pressure. A screw speed of the screw extruder may be between about 150 rpm to about 400 rpm. A percent torque of the screw extruder may be between about 20% to about 50%. A specific mechanical energy of the extruder may be between about 15 to about 75 Wh/kg.

In another aspect, the temperature of the agglomerated pulse dough within the barrel of the screw extruder may have a cylinder temperature within a range of about 45° C. to about 80° C. and a feeder temperature with a range of about 45° C. to about 85° C. The cylinder may have a pressure with a range of about 20-bar to about 90-bar.

In some aspects, the dried pasta may have a moisture content between about 7% to 12.5% by weight and the dried pasta may have protein in a range of about 7% to about 16% by weight. More particularly in some aspects, the dried pasta may have protein of about 12%.

In some aspects, the extruded pasta may be heated in a range of 50° C. to about 95° C. at atmospheric pressure. In particular, the extruded pasta may be heated in a range of about 60° C. to about 92° C. at atmospheric pressure.

According to any aspect, the screw extruder may be a twin screw mixer and extruder.

In yet another aspect, there is provided a pulse pasta produced from pulses. The pulse pasta may comprise: a protein of about 11.8% by weight; carbohydrates of about 73-90% by weight; and a moisture of about 10% by weight. The atmospheric cooking time of the pulse pasta may be in a range of about 7 to about 14 minutes. The pulses may be selected, but not limited to, from beans (Phaseolus vulgaris L.), peas (Pisum sativum L.), chickpeas (Cicer arietinum L.), faba beans (Vicia faba L.), lentils (Lens culinaris L.), and any combination thereof.

The above summary is not intended to describe each illustrated embodiment or every implementation of the subject matter hereof. The figures and the detailed description that follow more particularly exemplify various embodiments.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a flowchart for producing a pulse-based pasta according to one aspect;

FIG. 2 is a flowchart for producing the pulse-based pasta according to another aspect;

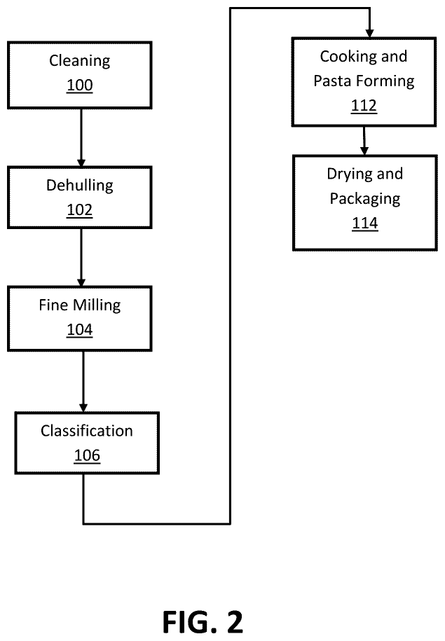

FIG. 3 is a flowchart for producing the pulse-based pasta according to yet another aspect; and

FIG. 4 is a sensory evaluation comparison of a pulse flour to a heat and moisture treated pulse-based flour.

### DETAILED DESCRIPTION OF THE DRAWINGS

There has been a recent increase in gluten-related disorders, such as celiac disease, nonceliac gluten sensitivity, wheat allergy, gluten ataxia, and dermatitis herpetiformis. As knowledge of these gluten-related disorders has increased, there has been a corresponding increase in the interest for gluten-free products. One such product comprises gluten-free pasta. Most conventional pasta contains some amount of gluten, especially if it is made from durum wheat flour. Pulse-based pasta may be suitable for gluten-free and allergen-free applications that may be consumed by celiac patients, non-celiac gluten allergy, and gluten sensitive consumers. Pulse-based pasta may be produced from pulses, such as, for example, peas, lentils, and faba beans. However, pulse flour and the pulse-based pasta made therefrom may have an unappealing aftertaste for some consumers.

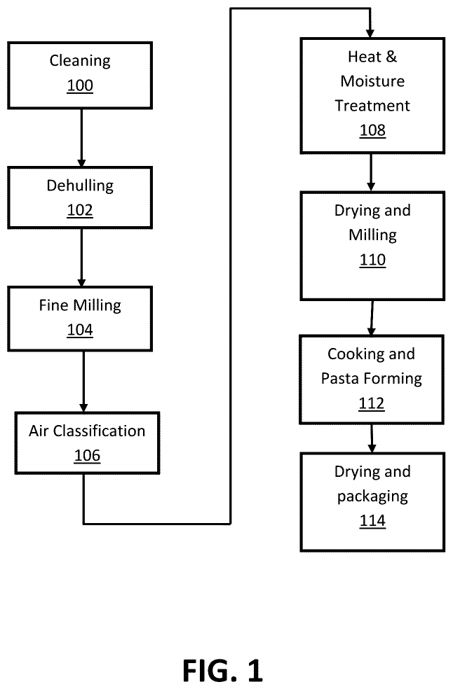

Generally, with reference to FIG. 1, pulse flours may be produced by cleaning 100, dehulling, 102, fine milling/grinding 104, classification 106, heat and moisture treatment 108, and drying and milling processes 110 in which the flow, taste, and/or sensory properties of the flour may be enhanced as described herein. For example, pasta made according to the process of FIG. 1 may exhibit a reduced pulse flavor and have a more roasted flavor. Although the aspects described herein are directed to peas, one or more of these techniques may equally apply to other pulses, such as, but not limited to, lentils, faba beans, navy beans, pinto beans, and/or black beans (or any combination thereof).

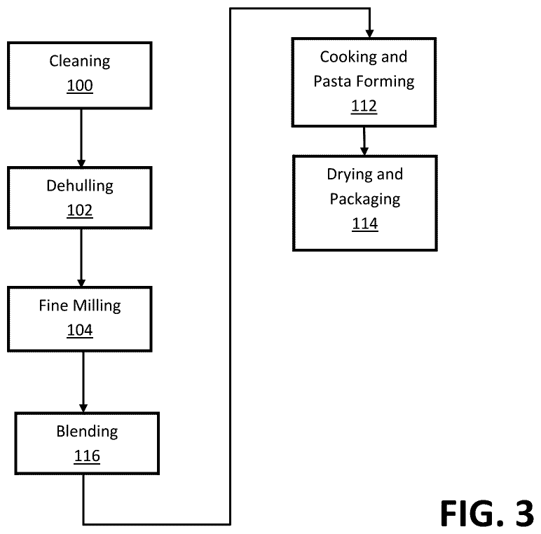

Pasta may be formed from the flour after step 104, 106, 108, or 110, depending on the desired flavor, by extruding and cooking 112, and drying and packaging 114 the pasta. One such example is demonstrated in FIG. 3 where the cleaning 100, dehulling 102, fine milling 104 may be performed. Following the fine milling 104, the pulse flour may be blended with a starch (step 116) to achieve the desired amount of protein. The pasta may then be formed and cooked (step 112) using the blended pulse flour and starch. The pasta may be dried and packaged 114. The pasta produced by this process may exhibit a stronger pulse flavor and no roasted flavor.

The cleaning process 100 may be applied to remove impurities from whole peas so that product cleanliness may be sustained. During the cleaning process 100, impurities such as chaff, other crops, stones, black-off colour kernels, damaged and/or broken seeds may be removed.

Dehulling 102 may be applied to produce dehulled pulses (e.g., split peas, split lentils, or split faba beans) and to remove outer hulls so that outer fiber portion of the peas may be removed to remove the fiber and to increase the yield of protein and starch separation. The outer hulls may be removed in the dehulling process 102 using mechanical forces applied by peelers. Since the hulls adhere on a cotyledon on the outer part of a kernel, these forces may help remove the outer hulls from the whole kernel and separate cotyledon.

Fine milling 104 process may be applied to the split peas to produce a raw pulse flour with a particle size of below about 80 microns. The particle size of below about 80 microns may assist in classification 106 in order to separate a starch fraction from a protein fraction. This particle size may apply particularly to peas, lentils, faba beans, and/or other low fat pulse crops. The fine milling 104 process may use various such as, for example, a pin mill, an ACM mill, a turbo jet mill, and/or other fine grinding systems. The lower particle size of the raw pulse flour may assist separation of the protein and starch granule. At this fine particle size, the protein bodies may be removed from starch granules using such techniques as described in at least U.S. Pat. No. 1,861,248 to Stebbins or U.S. Pat. No. 3,089,595 to Alpine Ag Maschinenfabrik Und.

During classification 106, the raw pulse flour may be separated into a limited protein pulse fraction with a protein range from about 7-16% dry weight. The medium protein pulse fraction having over between about 20% to about 32% dry weight protein may also be used within blending systems in pasta processing. The classification 106 may be performed by a classifier such as produced by Hosokawa Alpine Aktiengesellschaft, Sturtevant, etc.

Rather than classification 106, the limited protein pulse fraction may comprise medium (20-32%) level pulse flours (after fine milling 104) and may be blended with pea, lentil, and/or faba bean starch isolates (e.g., starch content >97% and protein <3%). Variable formulations are listed in Table 1. Pulse starch isolate may be used as texturizing agents combined with medium protein pulse flours to establish protein levels at a range of 7-16%.

TABLE 1

| | Blend | Blend | Blend | Blend | Blend | Blend |
|---|---|---|---|---|---|---|
| | 1 (% wt) | 2 (% wt) | 3 (% wt) | 4 (% wt) | 5 (% wt) | 6 (% wt) |
| Medium protein pulse | 50 | 50 | 50 | 40 | 40 | 40 |
| flour (23% protein) | | | | | | |
| Pea starch isolate | 50 | 0 | 0 | 60 | 0 | 0 |
| (2% protein) | | | | | | |
| Lentil starch isolate | 0 | 50 | 0 | 0 | 60 | 0 |
| (2% protein) | | | | | | |
| Faba bean starch | 0 | 0 | 50 | 0 | 0 | 60 |
| (2% protein) isolate | | | | | | |
| Typical Protein | 12.5 | 12.5 | 12.5 | 10.4 | 10.4 | 10.4 |
| Levels of | | | | | | |
| Blends (% wt) | | | | | | |

Heat and moisture treatment 108 may be applied to improve sensory and flavor attributes of the limited protein pulse flour fraction. The limited protein pulse flour fraction may also be agglomerated as part of the heat and moisture treatment 108. In some aspects, the agglomeration may be performed with a pasta press mixer kneader operating in a range of about 80-rpm to about 130-rpm. The initial moisture content of the limited protein pulse flour fraction before hydration may be between about 4% to about 12% and may be measured prior to hydration in order to determine the amount of hydration required. The limited protein pulse flour fraction may be hydrated in a range of between about 18 to about 50% by weight with water. In some aspects, the limited protein pulse flour fraction may be hydrated in a range of between about 20% to about 45% by weight with water. In other aspects, the limited protein pulse flour fraction may be hydrated in a range of between about 25% to about 40% by weight with water. In some particular aspects, the limited protein pulse fraction may be hydrated in a range of between about 27% to about 33% by weight with water. The water may have a temperature range of about 25° C. to about 85° C. The high temperature water and/or high pressure steam may be added and mixed to produce agglomerated dough granules. The hydrated flour may reach a temperature range of about 65° C. to about 80° C. The heat and moisture treatment 108 may comprise a hydrator, cooker and dryer (e.g., a reactor which has several functions) to partially gelatinize the limited protein pulse flour fraction. The agglomerated dough granules may be heated to a temperature of between about 95° C.-150° C. causing the granules to be cooked and dried to a moisture content of less than about 10% moisture.

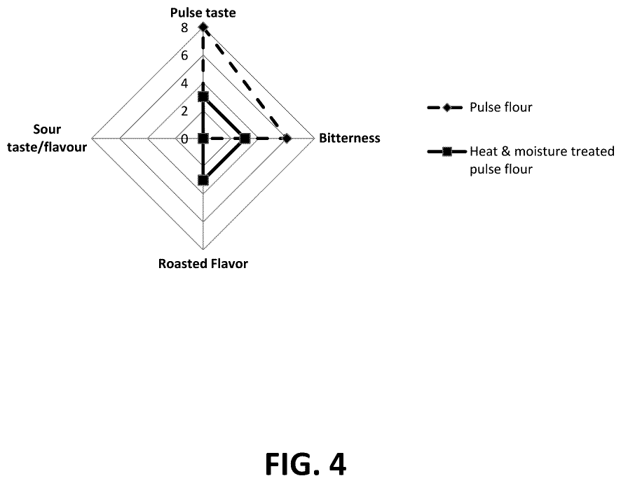

The hydration, heat, moisture treatment, and drying of the limited protein pulse flour fraction reduces levels of volatiles (e.g., hydrocarbons, alcohols, ketones, and/or aldehydes) as well as inactivates bitterness compounds (e.g., saponins, lectins and phenolics) improving the taste, flavour, and/or aroma. In particular, a sensory evaluation comparison presented in FIG. 4 demonstrates the altered taste, flavor, and/or aroma characteristics between the pulse flour and the heat and moisture treated pulse flour. In particular, a pulse taste has been reduced from a strong taste (e.g., 8) to a more mild pulse taste (e.g., 3). The bitterness has also been reduced by half (e.g., from 6 to 3). During the heat and moisture treatment, a roasted flavor may be introduced (e.g., from 0 to 3) into the pulse flour, which may be preferable to the pulse taste for a consumer.

The heat and moisture treated limited protein pulse flour may be milled 110 using a generic fine grinding system such as, for example, an ACM mill, pin mill, turbo jet mill, roller mill or any fine grinding system, and passed through a standard US 100 mesh having a sieve size of about 0.150 mm or other comparable mesh standard with a similar sieve size.

Once milled, the agglomerated flour may be mixed within a twin screw extruder with or without steam water to produce pulse dough with a rehydrated moisture content from about 25% to about 43% by weight to be used to prepare a gluten free pasta. In some aspects, the rehydrated moisture content may be from about 5% to about 25% addition by weight. In some aspects, the pulse dough may have a moisture content from about 27% to about 35% by weight. The mixing process may be between about 1 to about 5 minutes. In some aspects, no additional ingredients are added (e.g., a single ingredient pasta). In other aspects, an emulsifier (e.g., glycerol monostearate (GMS)) and/or hydrocolloids (e.g., gums) may be added at about 0.2% to about 1%.

The hydrated pulse dough may then enter an extrusion process 112 in which the wet dough may be formed and cut through a multi-zone temperature-controlled extruder/former and cooker. Forming of the pasta may take place in a single screw extruder or a twin screw extruder to cut the pasta to length. The extrusion process 112 may take between about 3 minutes to about 4 minutes. The extruder may have different mechanical configurations. The extruder includes a motor, a gear box, an extruder barrel, an extruder die, and a cutter. The extruder barrel may be formed of multiple barrel sections and may include at least one screw or at least two screws. The motor drives the screws which may mix, convey, and/or pressurize the pulse dough towards the die. The extruder die receives the pulse pasta dough and presses it through an aperture forming extruded pasta. The cutter may cut the extruded pasta into discrete pieces of a specific length.

A high temperature high shear cooking process may gelatinize starch granules, denature protein bodies and form a protein and starch network. The high-temperature cooking process may occur in the barrel at temperatures ranging from about 60° C. to about 120° C., or more particularly cooking may occur at temperatures ranging from about 50° C. to about 95° C. Product temperature inlet may be about 25° C. to about 30° C. Ambient room temperature initially. The screw speed for the twin-screw extruder may be between about 25-400 rpm. The percent torque for the twin screw extruder may be between about 20% to about 60% depending on production rate. The temperature of the pulse protein dough in the twin screw extruder may be between about 65-125° C.

In another aspect, the temperature of the agglomerated pulse dough within the barrel of the screw extruder may have a cylinder temperature within a range of about 45° C. to about 80° C. and a feeder temperature with a range of about 45° C. to about 85° C. The cylinder may have a pressure with a range of about 20-bar to about 90-bar.

Drying of cooked pasta 114 may be staged through pre-drying, drying, and stabilization steps. The drying process 114 conditions may be conducted according to the parameters given in Table 2. The drying process 114 may take between about 6 hours to about 7 hours for long goods (e.g., spaghetti, lasagna, fettuccine, etc.) and about 3 hours to about 5 hours for short goods (e.g., macaroni, conchiglie, farfalle, penne, etc.) at temperatures between about 80° C. and about 85° C. The cooked pasta moisture may be gradually reduced to less than about 12.5%, such as 10%, to produce a dried, finished pasta. In some aspects, the dried pasta may have a moisture content in the range of about 9% to about 13%. In some more aspects, the dried pasta may have a moisture content in the range of about 7% to about 13%. In some other aspects, the dried pasta may have a moisture content between about 11.7% to about 12.5%. In other aspects, the dried pasta may have a moisture content between about 5% to about 12.5%.

Drying of cooked pasta 114 may be staged through pre-drying, drying, and stabilization steps. The drying process 114 conditions may be conducted according to the parameters given in The dried pasta may have a thickness in the range of about 0.5-mm to about 2.2-mm. The pasta may have a cooked weight in a range of about 80% to about 150% of a dry weight. The cooked weight is the total weight of pasta after cooking/boiling process and provides an indication of a total % water absorption and % weight increase based on cooking time. The pasta may have a cooking loss in a range of 5% to 15%. The cooking loss is a total amount of dry materials lost after boiling pasta at atmospheric conditions.

The length of time for the drying process 114 may be calculated based on mass balance, hydration of the low-protein dough, the final moisture in the fresh dough prior to drying. The finished pasta may have a protein range of about 7-16% and may be a single ingredient pasta. In some aspects, the amount of protein may be about 12% (e.g., 11.8%). In other aspects, the amount of protein may be between about 4% to 16% and may have carbohydrates of about 80% by weight or in the range of about 80% to about 93% by weight. Texture of the finished pasta may be achieved by high and/or ultra-high temperature drying processes 114 in a range of about 60-92° C., or in a range of about 120-180° C. The pasta may have a thickness in the range of about 0.5-mm to about 2.2-mm.

TABLE 2

| Time | | Temperature | Relative Humidity (%) |
|---|---|---|---|
| 5 | min, | 65 C. | 80.0 |
| 65 | min. | 83 C. | 78.0 |
| 170 | min. | 80 C. | 76.0 |

The finished pasta may be prepared with atmospheric cooking conditions in a range of about 7 minutes to about 14 minutes. In other aspects, an atmospheric cooking time may be in the range of about 7 minutes to about 25 minutes. In canning applications, the finished pasta may be prepared with high pressure (e.g., 15-20 PSI) cooking conditions for 15-30 minutes. The finished pasta may have similar nutritional properties to durum wheat pasta in terms of proximate analysis and macronutrient properties. Typically, a product cook yield (%) varies between about 180% to about 250%; a product firmness varies from about 400 g-cm to about 5000 g-cm based on shape and size; and a cook loss (%) varies from about 8% to about 14%. The typical nutritional properties of finished pasta produced from peas is given in Table 3. The pasta produced by the technique described herein may have an average lysine level of 0.86%. In some aspects, the pasta produced by the techniques described herein may have an average potassium of approximately 6560 ppm, an average calcium of approximately 206 ppm, an average zinc of approximately 15.1 ppm, an average phosphorus of approximately 2050 ppm, a magnesium of approximately 523 ppm, and/or any combination thereof.

TABLE 3

| | Level | | | | |
|---|---|---|---|---|---|
| Analysis | Found | Units | Serving Size (100 g) | | Method |
| Moisture (Vacuum oven) | 10.0 | % | 10.0 | g | AOAC variable |
| Protein | 11.8 | % | 11.8 | g | MWL FO14 |
| Fat (Acid Hydrolysis) | 1.2 | % | 1.2 | g | AOAC 922.06 (mod) |
| Saturated fatty acids | 17.2 | % of fat | 0.2 | g | AOAC 996.06 |
| Mono-unsaturated fatty acids | 26 | % of fat | 0.3 | g | AOAC 996.06 |
| Poly-unsaturated fatty acids | 56.7 | % of fat | 0.7 | g | AOAC 996.06 |
| Trans fatty acids (total) | 0.1 | % of fat | 0 | g | AOAC 996.06 |
| Ash | 2 | % | 2 | g | MWL FO 022 |
| Carbohydrates | 80.1 | % | 80.1 | g | Calculation |
| Sucrose | 2.3 | % sugar | 2.3 | g | AOAC 982.14C (mod) |
| Total Sugars | 2.3 | % sugar | 2.3 | g | Calculation |
| Dietary fiber (total) | 4.6 | % | 4.6 | g | AOAC 991.43 (mod) |
| Dietary fiber (insoluble) | 4.6 | % | 4.6 | g | AOAC 991.43 (mod) |
| Calories | 378 | 21 CFR PART | | | |
| | | 101.9 (CALC) | | | |
| Sodium (total) | 31 | ppm | 3 | mg | AOAC 2011.14 (mod) |
| Potassium (total) | 6560 | ppm | 656 | mg | AOAC 2011.14 (mod) |
| Calcium (total) | 206 | ppm | 20.6 | mg | AOAC 2011.14 (mod) |
| Iron (total) | 41 | ppm | 4.1 | mg | AOAC 2011.14 (mod) |
| Aspartic acid | 1.45 | % | 1450 | mg | AOAC 994.12 (Alt. III) |
| Threonine | 0.48 | % | 480 | mg | AOAC 994.12 (Alt. III) |
| Serine | 0.59 | % | 590 | mg | AOAC 994.12 (Alt. III) |
| Glutamic acid | 2.16 | % | 2160 | mg | AOAC 994.12 (Alt. III) |
| Proline | 0.52 | % | 520 | mg | AOAC 994.12 (Alt. III) |
| Glycine | 0.83 | % | 830 | mg | AOAC 994.12 (Alt. III) |
| Alanine | 0.54 | % | 540 | mg | AOAC 994.12 (Alt. III) |
| Cystine | 0.23 | % | 230 | mg | AOAC 994.12 (Alt. III) |
| Valine | 0.57 | % | 570 | mg | AOAC 994.12 (Alt. III) |
| Methionine | 0.11 | % | 110 | mg | AOAC 994.12 (Alt. III) |
| Isoleucine | 0.54 | % | 540 | mg | AOAC 994.12 (Alt. III) |
| Leucine | 0.86 | % | 860 | mg | AOAC 994.12 (Alt. III) |
| Tyrosine | 0.41 | % | 410 | mg | AOAC 994.12 (Alt. III) |
| Phenylalanine | 0.59 | % | 590 | mg | AOAC 994.12 (Alt. III) |
| Lysine (total) | 0.86 | % | 860 | mg | AOAC 994.12 (Alt. III) |
| Histidine | 0.28 | % | 280 | mg | AOAC 994.12 (Alt. III) |
| Arginine | 0.92 | % | 920 | mg | AOAC 994.12 (Alt. III) |
| Tryptophan | 0.14 | % | 140 | mg | AOAC 994.12 (Alt. III) |
| Fiber-Sugar Sum | 6.9 | % | 6.9 | g | Calculation |
| Zinc (total) | 15.1 | ppm | 1.5 | mg | AOAC 2011.14 (mod) |
| Sulfur (total) | 932 | ppm | 93.2 | mg | AOAC 2011.14 (mod) |
| Phosphorus (total) | 2050 | ppm | 205 | mg | AOAC 2011.14 (mod) |
| Manganese (total) | 5 | ppm | 0.5 | mg | AOAC 2011.14 (mod) |
| Magnesium (total) | 523 | ppm | 52.3 | mg | AOAC 2011.14 (mod) |
| Copper (total) | 3.9 | ppm | 0.4 | mg | AOAC 2011.14 (mod) |
| Molybdenum (total) | 1.17 | ppm | 0.1 | mg | USP <233> |
| Starch (total) | 68.63 | % | 68.6 | g | AACC 76-11 (mod) |
| Selenium (total) | 0.26 | ppm | 0 | mg | USP <233> |

The temperature ranges described herein may be appropriate for an altitude of 560 m above sea level. One of skill in the art may adjust the temperatures according to the altitude where the processes described herein may be performed.

Although the aspects described herein demonstrate a dehulling 102 step, other aspects may perform fine milling 104 on the hulled pulses (or a portion of the hulled pulses) in order to provide a pasta product with additional fiber.

Any and all of the aspects described herein may be combined in any and all combinations consistent with the understanding of those skilled in the art. The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A pulse pasta produced from pulses comprising:
a protein of about 11.8% by weight or in a range of 4% to 16%;
carbohydrates of about 73% by weight or in a range of 73% to 90%; and
a moisture of about 10% by weight or in a range of 5% to 12.5%.

2. The pasta of claim 1, wherein an atmospheric cooking time is in a range of about 7 to about 25 minutes.

3. The pasta according to claim 1, wherein the pulses are selected from beans (Phaseolus vulgaris L.), peas (Pisum sativum L.), chickpeas (Cicer arietinum L.), lentils (Lens culinaris L.), faba beans (Vicia faba L.), and any combination thereof

4. The pasta according to claim 1, wherein the pasta has a thickness in a range of 0.5-mm to 2.2-mm.

5. A method of manufacturing a pasta from pulses comprises:
hydrating, within a vacuum mixer, a limited-protein pulse fraction to between about 18% to about 50% by weight with water in a temperature range of about 25° C. to 85° C. at atmospheric pressure to produce a hydrated pulse dough with a temperature range of about 65° C. to about 85° C.;
agglomerating the hydrated pulse dough to produce agglomerated pulse dough;
heating the agglomerated pulse dough at about 95° C. to about 150° C. to cook and dry the agglomerated pulse dough to a moisture content of less than about 10% moisture;
rehydrating the agglomerated pulse dough from at a moisture range from about 25% to about 43% by weight and cooking the agglomerated pulse dough in a barrel of a screw extruder to produce a cooked pulse dough;
extruding the cooked pulse dough to produce an extruded pasta; and
drying the extruded pasta to produce a dried pasta with a moisture content between about 5% to 12.5% by weight.

6. The method according to claim 5, further comprises separating, using classification, a raw pulse flour into the limited protein pulse fraction and a medium-protein pulse fraction.

7. The method according to claim 5, further comprises blending a medium-protein pulse fraction and a starch to produce the limited protein pulse fraction.

8. The method according to claim 5, further comprises milling at least one dehulled pulse to produce the raw pulse flour.

9. The method according to claim 8, further comprises dehulling at least one hulled pulse prior to milling to produce the at least one dehulled pulse and at least one outer hull.

10. The method according to claim 9, further comprising cleaning the at least one hulled pulse.

11. The method according to claim 8, wherein the raw pulse flour comprises particle sizes of below about 80-microns.

12. The method according to claim 5, wherein a protein range of the limited protein pulse fraction is less than about 16% dry weight.

13. The method according to claim 12, wherein the protein range of the limited protein pulse fraction is within a range of about 5% to about 16% dry weight.

14. The method according to claim 5, wherein the limited protein pulse fraction is hydrated to between about 25% to 43% by weight.

15. The method according to claim 14, wherein the limited protein pulse fraction is hydrated to between about 27% to about 33% by weight.

16. The method according to claim 5, further comprises milling the heated agglomerated pulse dough through a mesh having a sieve size of about 0.150-mm.

17. The method according to claim 5, wherein a temperature of the agglomerated pulse dough within the barrel of the screw extruder ranges from about 105° C. to about 125° C. at atmospheric pressure.

18. The method according to claim 5, wherein a cooking temperature within the barrel of the screw extruder ranges from about 45° C. to about 80° C. at atmospheric pressure.

19. The method according to claim 5, wherein a screw speed of the screw extruder is between about 150 rpm to about 400 rpm.

20. The method according to claim 5, wherein a percent torque of the screw extruder is between about 20% to about 50%.

21. The method according to claim 5, wherein the dried pasta has a moisture content between about 5%- to 12.5% by weight.

22. The method according to claim 5, wherein the dried pasta has a protein content in a range of about 4% to about 16% by weight.

23. The method according to claim 22, wherein the dried pasta has a protein content of about 12%.

24. The method according to claim 5, wherein the extruded pasta is heated in a range of 45° C. to about 85° C. at atmospheric pressure.

25. The method according to claim 5, wherein the extruded pasta is heated in a range of about 60° C. to about 92° C. at atmospheric pressure.

26. The method according to claim 5, wherein screw extruder is a twin screw mixer and extruder.

27. The method according to claim 5, further comprising a head pressure with a range of 20 bar to 90 bar.
